(19) United States
(12) Patent Application Publication
(10) Pub. No.: US 2021/0092427 A1
(43) Pub. Date: Mar. 25, 2021

(54) HARMONIZED EARLY TERMINATION IN BDOF AND DMVR IN VIDEO CODING

(71) Applicant: QUALCOMM Incorporated, San Diego, CA (US)

(72) Inventors: Chun-Chi Chen, San Diego, CA (US); Han Huang, San Diego, CA (US); Wei-Jung Chien, San Diego, CA (US); Marta Karczewicz, San Diego, CA (US)

(21) Appl. No.: 17/028,599

(22) Filed: Sep. 22, 2020

Related U.S. Application Data
(60) Provisional application No. 62/904,528, filed on Sep. 23, 2019.

(51) Int. Cl. H04N 19/50; H04N 19/172; H04N 19/176

(52) U.S. Cl. CPC H04N 19/50; H04N 19/176; H04N 19/172

(57) ABSTRACT

A video coder is configured to use bi-directional optical flow (BDOF) to determine, based on a first reference picture and a second reference picture, a prediction block for a current block of a current picture of the video data. The first reference picture is a first picture order count (POC) distance from the current picture. The second reference picture is a second POC distance from the current picture. The first POC distance must be equal to the second POC distance for BDOF to be used to determine the prediction block for the current block. The video coder codes, according to the video coding standard, the current block based on the prediction block for the current block.

This application claims the benefit of U.S. Provisional Patent Application 62/904,528, filed Sep. 23, 2019, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to bi-directional optical flow (BDOF) and decoder-side motion vector refinement (DMVR). The techniques of this disclosure may be applied to any of the existing video codecs, such as HEVC (High Efficiency Video Coding), VVC (Versatile Video Coding), Essential Video Coding (EVC) or be an efficient coding tool in any future video coding standards. As described herein, a video coder may use BDOF to determine, based on a first reference picture and a second reference picture, a prediction block for a current block of a current picture of the video data. The first reference picture is a first picture order count (POC) distance from the current picture. The second reference picture is a second POC distance from the current picture. In some examples, the first POC distance must be equal to the second POC distance for BDOF to be used to determine the prediction block for the current block. Imposition of this requirement may harmonize early termination conditions between BDOF and DMVR.

In one example, this disclosure describes a method of coding video data, the method comprising: using bi-directional optical flow (BDOF) to determine, based on a first reference picture and a second reference picture, a prediction block for a current block of a current picture of the video data, wherein: the first reference picture is a first picture order count (POC) distance from the current picture, the second reference picture is a second POC distance from the current picture, and the first POC distance must be equal to the second POC distance for BDOF to be used to determine the prediction block for the current block; and coding, according to the video coding standard, the current block based on the prediction block for the current block.

In another example, this disclosure describes a device for coding video data, the device comprising: a memory to store the video data; and one or more processors implemented in circuitry, the one or more processors configured to: use bi-directional optical flow (BDOF) to determine, based on a first reference picture and a second reference picture, a prediction block for a current block of a current picture of the video data, wherein: the first reference picture is a first picture order count (POC) distance from the current picture, the second reference picture is a second POC distance from the current picture, and the first POC distance must be equal to the second POC distance for BDOF to be used to determine the prediction block for the current block; and code, according to the video coding standard, the current block based on the prediction block for the current block.

In another example, this disclosure describes a device for coding video data, the device comprising: means for using bi-directional optical flow (BDOF) to determine, based on a first reference picture and a second reference picture, a prediction block for a current block of a current picture of the video data, wherein: the first reference picture is a first picture order count (POC) distance from the current picture, the second reference picture is a second POC distance from the current picture, and the first POC distance must be equal to the second POC distance for BDOF to be used to determine the prediction block for the current block; and means for coding, according to the video coding standard, the current block based on the prediction block for the current block.

In another example, this disclosure describes a computer-readable storage medium having stored thereon instructions that, when executed, cause one or more processors to: use bi-directional optical flow (BDOF) to determine, based on a first reference picture and a second reference picture, a prediction block for a current block of a current picture of the video data, wherein: the first reference picture is a first picture order count (POC) distance from the current picture, the second reference picture is a second POC distance from the current picture, and the first POC distance must be equal to the second POC distance for BDOF to be used to determine the prediction block for the current block; and code, according to the video coding standard, the current block based on the prediction block for the current block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2A is a conceptual diagram illustrating spatial neighboring motion vector (MV) candidates for merge mode.

FIG. 2B is a conceptual diagram illustrating spatial neighboring MV candidates for AMVP mode.

FIG. 3A is a conceptual diagram illustrating an example temporal motion vector predictor (TMVP) candidate.

FIG. 3B is a conceptual diagram illustrating an example of MV scaling.

FIG. 4 is a conceptual diagram illustrating bilateral template matching.

FIG. 5 is a conceptual diagram illustrating an example extended coding unit (CU) region used in bi-directional optical flow (BDOF).

FIG. 6 is a block diagram illustrating an example video encoder that may perform the techniques of this disclosure.

FIG. 7 is a block diagram illustrating an example video decoder that may perform the techniques of this disclosure.

FIG. 8 is a flowchart illustrating an example method for encoding a current block.

FIG. 9 is a flowchart illustrating an example method for decoding a current block of video data.

FIG. 10 is a flowchart illustrating an example method that may be performed by a video coder in accordance with one or more techniques of this disclosure.

### DETAILED DESCRIPTION

Bi-directional optical flow (BDOF) and decoder-side motion vector refinement (DMVR) are coding tools that may be used a motion compensation process during video coding. Each of BDOF and DMVR are associated with early termination conditions. If the early termination conditions of BDOF are satisfied, a video coder (e.g., a video encoder or a video decoder) may perform a BDOF process. Otherwise, if the early termination conditions for BDOF are not satisfied, the video coder does not perform the BDOF process. Similarly, if the early termination conditions for DMVR are satisfied, the video coder may perform the DMVR process. If the early termination conditions for DMVR are not satisfied, the video coder does not perform the DMVR process.

Bross, et al. “Versatile Video Coding (Draft 6),” Joint Video Experts Team (JVET) of ITU-T SG 16 WP 3 and ISO/IEC JTC 1/SC 29/WG 11, 15^{th} Meeting: Gothenburg, S E, 3-12 Jul. 2019, JVET-02001-vE (hereinafter “VVC Draft 6”) is a recent draft of the VVC standard. In VVC Draft 6, the early termination conditions for BDOF do not match the early termination conditions for DMVR. Specifically, an early termination condition for DMVR requires that the distances (i.e. POC difference) from both reference pictures to the current picture are the same. However, an early termination condition for BDOF requires that one of the two reference pictures is prior to the current picture in display order and the other is after the current picture in display order, but does not require the reference pictures to have the same POC differences from the current picture. As a result of the differences in the early termination conditions of BDOF and DMVR, a video coder may need to perform separate checks, and in some examples include separate hardware, for the early termination conditions for BDOF and the early termination conditions for DMVR. This may increase the complexity of the video coder, increase cost, and may slow down the coding process.

This disclosure describes techniques that may address such issues. For instance, in one example, a video coder (e.g., a video encoder or a video decoder) may use bi-directional optical flow (BDOF) to determine, based on a first reference picture and a second reference picture, a prediction block for a current block of a current picture of the video data. The first reference picture is a first picture order count (POC) distance from the current picture. The second reference picture is a second POC distance from the current picture. The first POC distance must be equal to the second POC distance for BDOF to be used to determine the prediction block for the current block. For instance, a constraint may be imposed by a video coding standard, such as VVC or another video coding standard, where the constraint requires the first POC distance to be equal to the second POC distance. The video coder may code, according to the video coding standard, the current block based on the prediction block for the current block. Requiring the first POC distance to be equal to the second POC distance to BDOF to be used may at least partially harmonize the early termination conditions for BDOF and DMVR, and may therefore lead to a reduction in the complexity of the video coder.

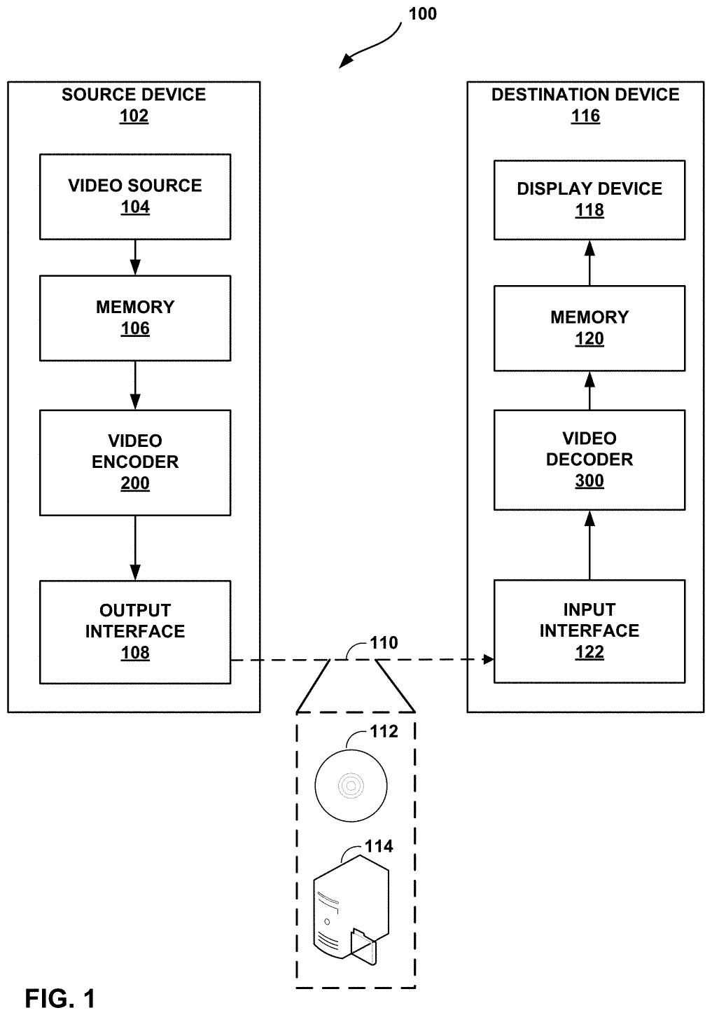

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, mobile devices (e.g., notebook (i.e., laptop) computers, tablet computers, telephone handsets such as smartphones, cameras, etc.), set-top boxes, broadcast receiver devices, televisions, display devices, digital media players, video gaming consoles, video streaming devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply techniques related to DMVR and BDOF. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques related to DMVR and BDOF. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, computer-readable medium 110 may include storage device 112. Source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, computer-readable medium 110 may include file server 114 or another intermediate storage device that may store the encoded video data generated by source device 102. Source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). VVC Draft 6 is a recent draft of the VVC standard. The techniques of this disclosure, however, are not limited to any particular coding standard. J. Chen et al., “Algorithm description of Versatile Video Coding and Test Model 4 (VTM 4),” Joint Video Experts Team (WET) of ITU-T SG 16 WP 3 and ISO/IEC JTC 1/SC 29/WG 11, 15^{th} Meeting: Marrakech, M A, 9-18 Jan. 2019, JVET-M1002, is an algorithm description and test model of VVC.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

In HEVC, the largest coding unit in a slice is called a coding tree block (CTB) or coding tree unit (CTU). A CTB contains a quad-tree the nodes of which are coding units. The size of a CTB can range from 16×16 to 64×64 in the HEVC main profile (although technically 8×8 CTB sizes can be supported). A coding unit (CU) could be the same size of a CTB to as small as 8×8. Each coding unit is coded with one mode, i.e., inter or intra. When a CU is inter coded, the CU may be further partitioned into 2 or 4 prediction units (PUs) or become just one PU when further partition does not apply. When two PUs are present in one CU, they can be half size rectangles or two rectangle size with ¼ or ¾ size of the CU. When the CU is inter coded, each PU has one set of motion information, which is derived with a unique inter prediction mode.

In the HEVC standard, there are two inter prediction modes, named merge (skip is considered as a special case of merge) and advanced motion vector prediction (AMVP) modes respectively for a prediction unit (PU). In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures used for the prediction of the current blocks, as well as the associated motion vectors are determined. On the other hand, under AMVP mode for each potential prediction direction from either list 0 or list 1, a reference index needs to be explicitly signaled, together with an MV predictor (MVP) index to the MV candidate list since the AMVP candidate contains only a motion vector. In AMVP mode, the predicted motion vectors can be further refined. The candidates for both modes are derived similarly from the same spatial and temporal neighboring blocks.

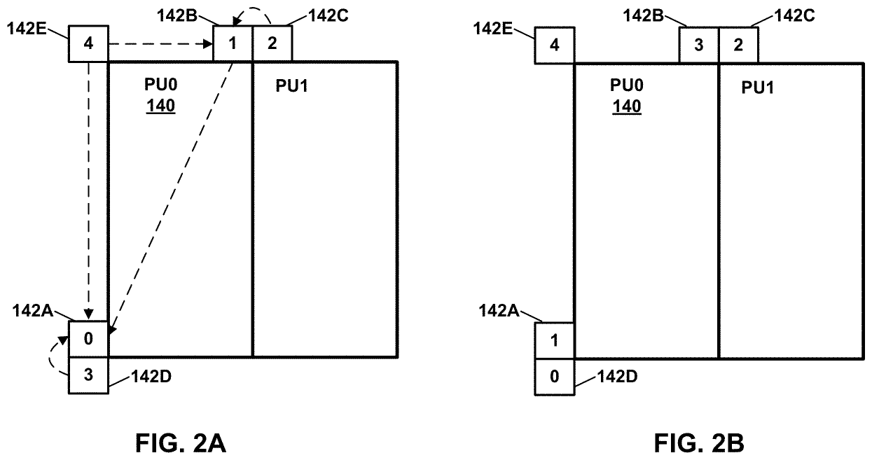

Spatial MV candidates are derived from the neighboring blocks shown in FIG. 2A and FIG. 2B for a specific PU (PU₀) (140), although the methods generating the candidates from the blocks differ for merge and AMVP modes. FIG. 2A is a conceptual diagram illustrating spatial neighboring MV candidates for merge mode. FIG. 2B is a conceptual diagram illustrating spatial neighboring MV candidates for AMVP mode.

In merge mode, up to four spatial MV candidates can be derived with the orders shown in FIG. 2A with numbers, and the order is the following: left (0, A1), above (1, B1), above right (2, B0), below left (3, A0), and above left (4, B2), as shown in FIG. 2A.

In AMVP mode, the neighboring blocks 142A-142E are divided into two groups: a left group consisting of the block 0 and 1, and an above group consisting of the blocks 2, 3, and 4 as shown in FIG. 2B. For each group, the potential candidate in a neighboring block referring to the same reference picture as that indicated by the signaled reference index has the highest priority to be chosen to form a final candidate of the group. It is possible that none of the neighboring blocks contain a motion vector pointing to the same reference picture. Therefore, if such a candidate cannot be found, the first available candidate will be scaled to form the final candidate; thus the temporal distance differences can be compensated.

A temporal motion vector predictor (TMVP) candidate, if enabled and available, may be added into the MV candidate list after spatial motion vector candidates. The process of motion vector derivation for TMVP candidate is the same for both merge and AMVP modes; however, the target reference index for the TMVP candidate in the merge mode is always set to 0.

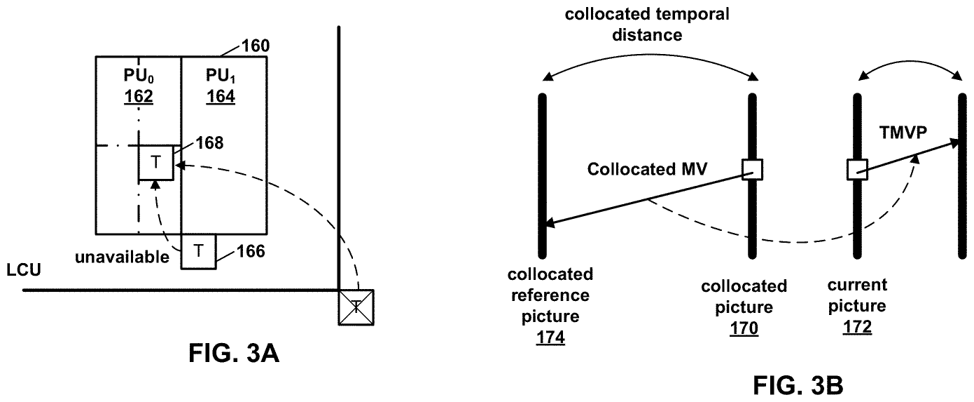

The primary block location for TMVP candidate derivation is the bottom right block outside of the collocated PU as shown in FIG. 3A as a block “T”, to compensate the bias to the above and left blocks used to generate spatial neighboring candidates. However, if that block is located outside of the current CTB row or motion information is not available, the block is substituted with a center block of the PU.

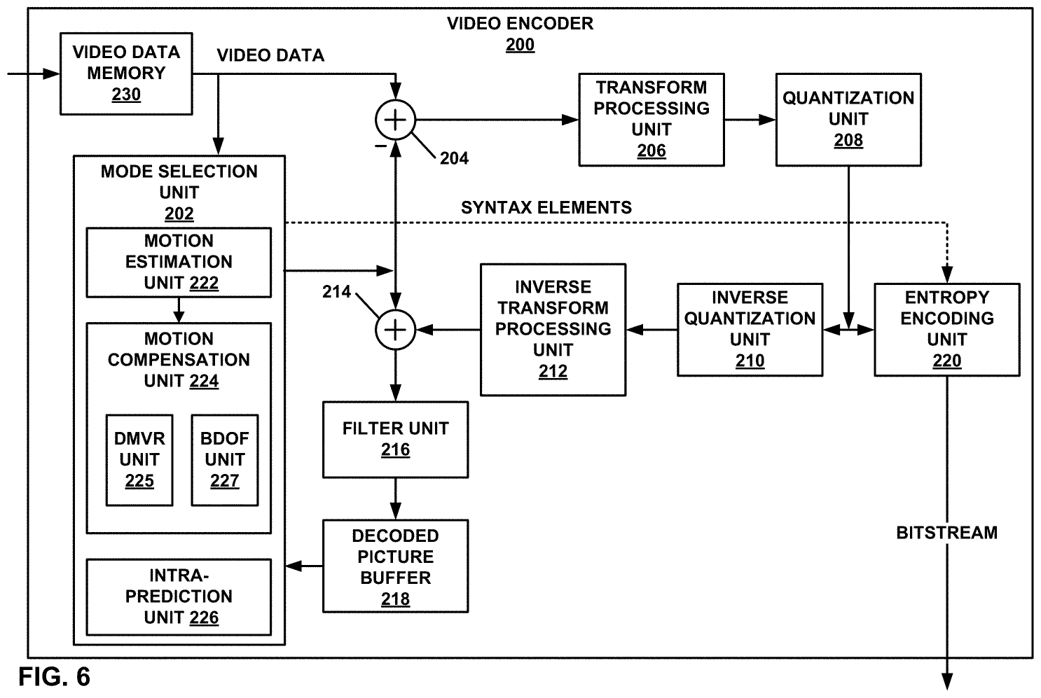

FIG. 3A is a conceptual diagram illustrating a TMVP candidate. In the example of FIG. 6, a CU 160 includes a first PU 162 (denoted PU₀) and a second PU 164 (denoted PU₁). In the example of FIG. 3A, a primary block location 166 for TMVP candidate derivation is the bottom right block outside of the collocated PU (shown in FIG. 3A as a block “T”), to compensate for the bias to the above and left blocks used to generate spatial neighboring candidates. However, if the block at primary block location 166 is located outside of a current CTB row or motion information is not available, the block is substituted with a center block 168 of PU 602. A motion vector for a TMVP candidate is derived from the co-located PU of the co-located picture, indicated in the slice level. The motion vector for the co-located PU is called a collocated MV. Similar to temporal direct mode in H.264/AVC, to derive the TMVP candidate motion vector, the co-located MV may need to be scaled to compensate for the temporal distance differences, e.g., as shown in FIG. 3B.

FIG. 3B is a conceptual diagram illustrating MV scaling. In the example of FIG. 3B, a collocated picture 170 for a current picture 172 includes a motion vector (i.e., a collocated motion vector) that indicates a location in a collocated reference picture 174. A temporal distance between collocated picture 170 and collocated reference picture 174 is referred to as the collocated temporal distance. Furthermore, in AMVP, a reference index for a current block of current picture 172 indicates a current reference picture 176. A temporal distance between current picture 172 and current reference picture 176 is referred to as a current temporal distance. A video coder may use collocated motion vector as a temporal motion vector predictor (TMVP) of the block in current picture 172 but may scale the collocated motion vector based on a difference between the collocated temporal distance and the current temporal distance.

Thus, to determine a L0 AMVP candidate list, the video coder may determine whether there is an available neighboring block in the left group that has a L0 motion vector. A neighboring block may be considered available if the neighboring block exists and the video coder is able to access motion information regarding the neighboring block. Furthermore, if the left group includes an available neighboring block that has a L0 motion vector, the video coder may include the L0 motion vector in the L0 AMVP candidate list. Additionally, the video coder may determine whether there is an available neighboring block in the above group that has a L0 motion vector. If the above group includes an available neighboring block that has a L0 motion vector, the video coder may include the L0 motion vector in the L0 AMVP candidate list. In some examples, if the left group and/or the above group includes no available L0 motion vectors, the video coder may include a L0 motion vector of a temporal neighbor. In some such examples, if the temporal neighbor is not available or does not have an L0 motion vector, the video coder may include a zero-valued motion vector in the L0 AMVP candidate list. The video coder may perform the same process with L0 replaced with L1 to determine a L1 AMVP candidate list.

Several aspects of merge and AMVP modes are presented below.

Motion vector scaling: It is assumed that the value of a motion vector is proportional to the distance of picture in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values.

For a motion vector to be predicted, a containing picture and reference picture associated with the motion vector may be different. Therefore, new distances (based on POC) may be calculated. The motion vector may be scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial motion vector candidate generation: If a motion vector candidate list is not complete, artificial motion vector candidates are generated and inserted at the end of the list until the MV candidate list has all candidates. In merge mode, there are two types of artificial MV candidates: (1) combined candidates derived only for B-slices and (2) zero candidates used only for AMVP if the first type does not provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

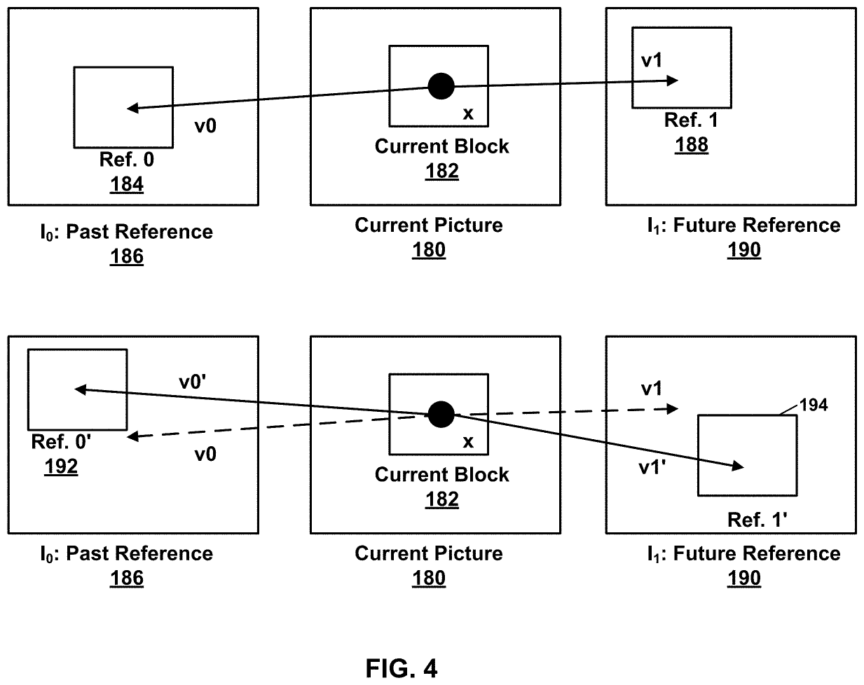

Pruning process for candidate insertion: Candidates from different blocks may happen to be the same, which decreases the efficiency of a merge/AMVP candidate list. A pruning process is applied to solve this problem. It compares one candidate against the others in the current candidate list to avoid inserting identical candidate in certain extent. To reduce the complexity, only limited numbers of pruning processes are applied instead of comparing each potential one with all the other existing ones. Decoder-side Motion Vector Refinement (DMVR) is a variant of decoder-side MV derivation techniques to avoid the template-based refinement process. This technique computes the bilateral matching cost directly between the uni-prediction reference blocks (denoted as I₀(x+v₀) and I₁(x+v₁) and x as the coordinate of a pixel within the current block) pointed to by the initial bi-prediction MVs (e.g. v₀ and v₁ as in FIG. 4). FIG. 4 is a conceptual diagram that illustrates bilateral template matching. In the example of FIG. 4, a current picture 180 includes a current block 182. Current block 182 has an L0 motion vector that indicates a location corresponding to an area 184 (denoted Ref. 0) in a past reference picture 186. Current block 182 also has an L1 motion vector that indicates a location corresponding to an area 188 in a future reference picture 190. A video coder (e.g., a video encoder or a video decoder) performs a local search based on bilateral matching within a pre-defined 5×5 search range around the initial bi-prediction MVs. Following the raster-scanning order from the top-left of the 5×5 window, the DMVR process finds an optimal delta MV (i.e. Δ). The optimal delta MV is a delta MV that leads to the lowest bilateral matching cost, where the cost function is defined as the distortion between I₀(x+v₀+Δ) and I₁(x+v₁−Δ). A delta MV is a tuple that includes x and y values that are added to or subtracted from x and y values of the bi-prediction MVs. The optimal delta MV may be denoted by Δ*. The distortion function that is used in the current VVC standard is Sum of Absolute Difference (SAD).

The video coder may then refine the output MV pair (denoted as v₀+* and v₁−Δ*, wherein Δ* is the optimized A within the pre-defined 5×5 window) again at sub-pel precision. The video coder may take the resulting MV pair to replace the original MVs (v₀⁽⁰⁾ and v₁⁽⁰⁾) of the merge block. The video coder may then perform motion compensation based on the refined MVs. Thus, in the example of FIG. 4, the video coder may determine areas 192 and 194 corresponding to locations Ref0′ and Ref1′ indicated by the refined MV pair.

In a test model for VVC Draft 6 (VTM-6.0), the DMVR process can be applied for a CU if each of the following conditions are satisfied:
CU level merge mode with bi-prediction MV.
One reference picture is in the past and another reference picture is in the future with respect to the current picture.
The distances (i.e. POC difference) from both reference pictures to the current picture are the same.
The CU is not coded using affine mode or the ATMVP merge mode.
CU has more than 64 luma samples.
Both CU height and CU width are larger than or equal to 8 luma samples.
Bi-prediction with CU weights (BCW) weight index indicates equal weight.
Weighted Prediction (WP) is not enabled for the current block, and
Combined Inter and Intra Prediction (CIIP) mode is not used for the current block.
   In other words, a video coder uses the above early termination conditions for DMVR. The early termination conditions for DMVR may be considered to be satisfied if each of the above conditions is satisfied.

Bi-directional optical flow (BDOF) is used to refine the bi-prediction signal of luma samples in a CU at the 4×4 sub-block level. As its name indicates, the BDOF mode is based on the optical flow concept, which assumes that the motion of an object is smooth. For each 4×4 sub-block, a motion refinement (vₓ, v_{y}) is calculated by minimizing the difference between the L0 and L1 prediction samples. The motion refinement is then used to adjust the bi-predicted sample values in the 4×4 sub-block. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( {I}^{( k )} ( i + 1 , j ) - {I}^{( k )} ( i - 1 , j ) ) ≫ shift 1$$

$$\frac{\partial {I}^{( k )}}{\partial y} ( i , j ) = ( {I}^{( k )} ( i , j + 1 ) - {I}^{( k )} ( i , j - 1 ) ) ≫ shift 1$$

where I^{(k)}(i,j) are the sample value at coordinate (i,j) of the prediction signal in list k, k=0,1, and shift1 is calculated based on the luma bit depth, bitDepth, as shift1=max(2, 14−bitDepth).

Then, the auto- and cross-correlation of the gradients, S₁, S₂, S₃, S₅ and S₆, are calculated as

$${S}_{1} = {\sum }_{( i , j ) ∈ Ω} {ψ}_{x} ( i , j ) \cdot {ψ}_{x} ( i , j ) , \\ {S}_{3} = {\sum }_{( i , j ) ∈ Ω} θ ( i , j ) \cdot {ψ}_{x} ( i , j )$$

$${S}_{2} = {\sum }_{( i , j ) ∈ Ω} {ψ}_{x} ( i , j ) \cdot {ψ}_{y} ( i , j )$$

$${S}_{5} = {\sum }_{( i , j ) ∈ Ω} {ψ}_{y} ( i , j ) \cdot {ψ}_{y} ( i , j )$$

$${S}_{6} = {\sum }_{( i , j ) ∈ Ω} θ ( i , j ) \cdot {ψ}_{y} ( i , j ) where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 sub-block, and the values of nₐ and n_{b} are set equal to min(5, bitDepth−7) and min(8, bitDepth−4), respectively.

The motion refinement (vₓ, v_{y}) is then derived using the cross- and auto-correlation terms using the following:

vₓ=S₁>0?clip3(−th_{BIO}′,th_{BIO}′,−((S₃·2ⁿ^{_{b}}⁻ⁿa)>>└log₂S₁┘)):0

v_{y}=S₅>0?clip3(−th_{BIO}′,th_{BIO}′,−((S₆·2ⁿ^{_{b}}⁻ⁿ^{ₐ}−((vₓS_{2,m})<<n_{S}_{₂}+vₓS_{2,s})/2)>>└log₂S₅┘)):0

where

$${S}_{2 , m} = {S}_{2} ≫ {n}_{{S}_{2}} , {S}_{2 , s} = {S}_{2} \& ( {2}^{{n}_{{S}_{2}}} - 1 ) , {th}_{BIO}^{′} = {2}^{13 - BD} .$$

th_{BIO}′=2^{13-BD}. └⋅┘ is the floor function, and n_{S}_{₂}=12.

Based on the motion refinement and the gradients, the following adjustment is calculated for each sample in the 4×4 sub-block:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) ) / 2 ) + rnd ( ( {v}_{y} ( \frac{\partial {I}^{( 1 )} ( x , y )}{\partial y} - \frac{\partial {I}^{( 0 )} ( x , y )}{\partial y} ) ) / 2 )$$

The BDOF samples of the CU are calculated by adjusting the bi-prediction samples as follows:

pred_{BDOF}(x,y)=(I⁽⁰⁾(x,y)+I⁽¹⁾(x,y)+b(x,y)+o_{offset})>>shift

These values are selected such that the multipliers in the BDOF process do not exceed 15 bits, and the maximum bit-width of the intermediate parameters in the BDOF process is kept within 32 bits.

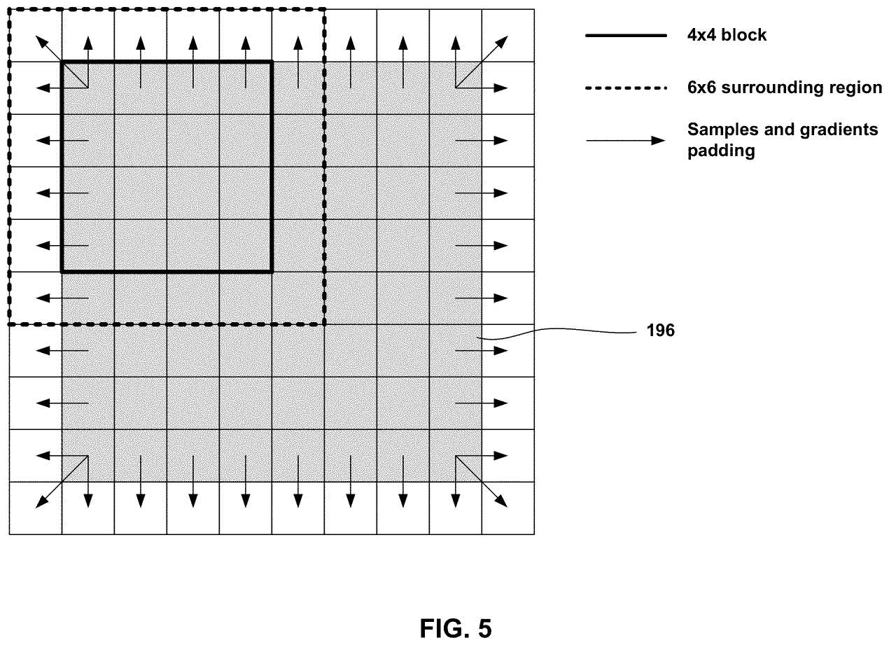

In order to derive the gradient values, some prediction samples I^{(k)}(i,j) in list k (k=0,1) outside of the current CU boundaries need to be generated. As depicted in FIG. 5, the BDOF uses one extended row/column around the boundaries of a CU 196. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculations only. For the remaining steps in the BDOF process, if any sample and gradient values outside of the CU boundaries are needed, the sample and gradient values are padded (i.e., repeated) from their nearest neighbors.

BDOF may be used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The CU is not coded using affine mode or the ATMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.
   In other words, a video coder uses the above early termination conditions for BDOF. The early termination conditions for BDOF may be considered to be satisfied if each of the above conditions is satisfied.

In VVC Draft 6, both BDOF and DMVR apply their own CU-level early terminations respectively to skip their respective processes during the motion compensation stage. The conditions that are imposed on BDOF for early termination are almost identical to those imposed on DMVR, except for their POC-distance constraints. DMVR requires that its bi-prediction reference pictures must come respectively from the past and future in display order, each with the equal absolute POC distance relative to the current picture. However, BDOF takes a more relaxed constraint as compared to how DMVR does. With BDOF, reference pictures need not have an absolute POC distance equal to each other's POC distance, resulting in two separate conditional checks during motion compensation stage for both coding tools. If the two conditional checks respectively for DMVR and BDOF can be harmonized, only a single conditional check is needed and can be calculated once during the motion compensation stage.

This disclosure describes techniques that may address this issue. For instance, in some examples of this disclosure, the equal-POC-distance constraint is removed from DMVR. In some examples of this disclosure, DMVR can remove its equal-POC-distance constraint, so that DMVR only requires that one of its reference pictures comes from the past in display order and the other comes from the future in display order. Therefore, the early termination conditions of DMVR exactly match the early termination conditions of BDOF.

Hence, in some examples of this disclosure, a video coder (e.g., video encoder 200 or video decoder 300) may use DMVR to determine, based on a first reference picture and a second reference picture, the prediction block for a current block of a current picture of the video data, wherein the first reference picture is a first POC distance from the current picture and the second reference picture is a second POC distance from the current picture. In accordance with some examples of this disclosure, the first POC distance is not required to be equal to the second POC distance. The video coder may code the current block based on the prediction block for the current block.

In some examples of this disclosure, equal-POC-distance is imposed on BDOF. In other words, BDOF can impose the equal-POC-distance constraint on itself, so that BDOF requires that its bi-prediction reference pictures must come respectively from the past and future in display order, each with the equal absolute POC distance relative to the current picture. Therefore, the early-termination condition of BDOF is exactly matching that of DMVR.

Hence, in some examples of this disclosure, a video coder (e.g., video encoder 200 or video decoder 300) may use BDOF to determine, based on a first reference picture and a second reference picture, the prediction block for a current block of a current picture of the video data. In such examples, the first reference picture is a first POC distance from the current picture and the second reference picture is a second POC distance from the current picture. In such examples, the first POC distance must be equal to the second POC distance for the video coder to use BDOF to determine the prediction block for the current block. For instance, a first constraint may be imposed by a video coding standard (e.g., VVC or another video coding standard). The first constraint requires the first POC distance to be equal to the second POC distance. In some examples, the first reference picture must be before the current picture in a display order and the second reference picture must be after the current picture in the display order for BDOF to be used to determine the prediction block for the current block. For instance, the video coding standard may impose a second constraint that requires the first reference picture to be before the current picture in a display order and the second reference picture to be after the current picture in the display order. The video coder may code the current block according to the video coding standard based on the prediction block for the current block.

FIG. 6 is a block diagram illustrating an example video encoder 200 that may perform the techniques of this disclosure. FIG. 6 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards and are applicable generally to video encoding and decoding.

In the example of FIG. 6, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 6 are illustrated to assist with understanding the operations performed by video encoder 200. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like. In the example of FIG. 6, motion compensation unit 224 includes a DMVR unit 225 and a BDOF unit 227.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

DMVR unit 225 of motion compensation unit 224 may use a DMVR process as part of the motion compensation process to generate a prediction block. An example of the DMVR process is described elsewhere in this disclosure. DMVR unit 225 may check one or more early termination conditions for the DMVR process. If the early termination conditions are satisfied, DMVR unit 225 may continue the DMVR process and use DMVR to generate the prediction block. Otherwise, if one or more of the early termination conditions are not satisfied, motion compensation unit 224 may generate the prediction block without using the DMVR process. In some examples of this disclosure, one or more of the early termination conditions for DMVR are modified relative to the early termination conditions for DMVR set forth in VVC Draft 6. Specifically, as one example the equal-POC-distance constraint may be removed from the early termination conditions. Thus, in some examples, DMVR unit 225 may perform the DMVR process even if the first reference picture and the second reference picture are not equal POC distances from the current picture.

BDOF unit 227 of motion compensation unit 224 may use a BDOF process as part of the motion compensation process to generate a prediction block. An example of the BDOF process is described elsewhere in this disclosure. BDOF unit 227 may check one or more early termination conditions for the BDOF process. If the early termination conditions are satisfied, BDOF unit 227 may continue the BDOF process and use BDOF to generate the prediction block. Otherwise, if one or more of the early termination conditions are not satisfied, motion compensation unit 224 may generate the prediction block without using the BDOF process. In some examples of this disclosure, one or more of the early termination conditions for BDOF are modified relative to the early termination conditions for BDOF set forth in VVC Draft 6. Specifically, as one example, the equal-POC-distance constraint may be applied in the early termination conditions for BDOF. Thus, in some examples, BDOF unit 227 may perform the BDOF process only if the first reference picture and the second reference picture are equal POC distances from the current picture.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying an MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to use decoder-side motion vector refinement (DMVR) to determine, based on a first reference picture and a second reference picture, the prediction block for a current block of a current picture of the video data, wherein the first reference picture is a first POC distance from the current picture, and the second reference picture is a second POC distance from the current picture. In accordance with some examples of this disclosure, the first POC distance is not required to be equal to the second POC distance. In some examples, motion estimation unit 222 and/or motion compensation unit 224 uses DMVR to determine the prediction block for the current block. The one or more processors of video encoder 200 may encode the current block based on the prediction block for the current block.

In some examples of this disclosure, one or more processing units of video encoder 200 may use BDOF to determine, based on a first reference picture and a second reference picture, the prediction block for a current block of a current picture of the video data, wherein: the first reference picture is a first POC distance from the current picture, and the second reference picture is a second POC distance from the current picture. In such examples, the first POC distance must be equal to the second POC distance for BDOF to be used to determine the prediction block for the current block. For instance, at least a first constraint is imposed by a video coding standard (e.g., VVC or another video coding standard). The first constraint requires the first POC distance to be equal to the second POC distance. In some examples, the first reference picture must be before the current picture in a display order and the second reference picture must be after the current picture in the display order for BDOF to be used to determine the prediction block for the current block. For instance, the video coding standard may also impose a second constraint requiring the first reference picture to be before the current picture in a display order and the second reference picture to be after the current picture in the display order. In some examples, motion estimation unit 222 and/or motion compensation unit 224 uses BDOF to determine the prediction block for the current block. The one or more processors of video encoder 200 may encode the current block according to the video coding standard based on the prediction block for the current block.

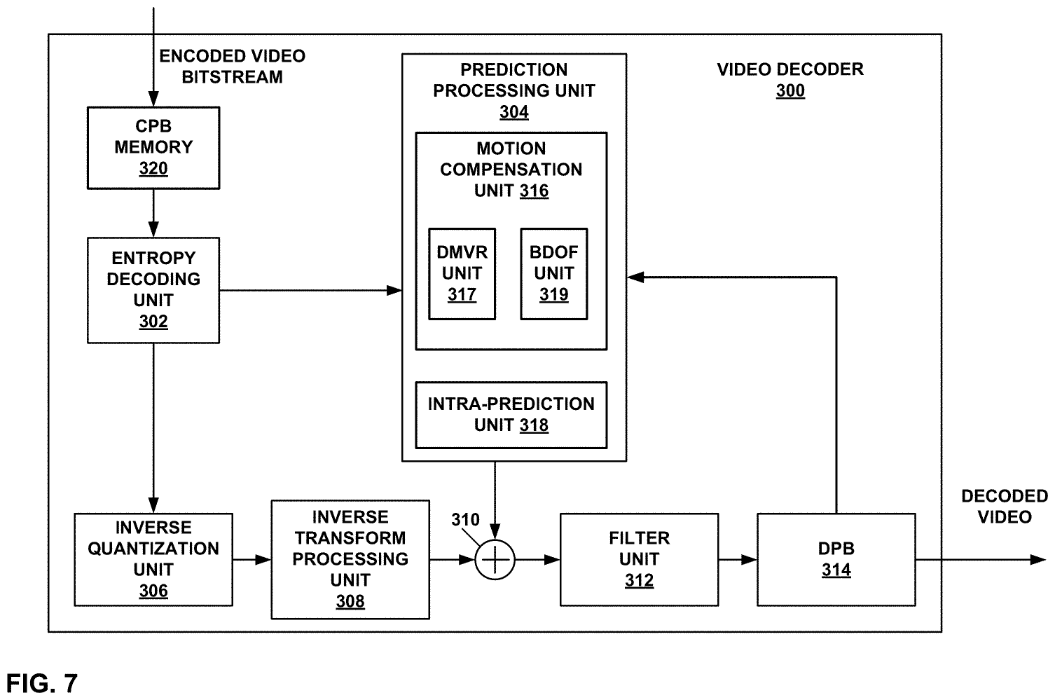

FIG. 7 is a block diagram illustrating an example video decoder 300 that may perform the techniques of this disclosure. FIG. 7 is provided for purposes of explanation and is not limiting on the techniques as broadly exemplified and described in this disclosure. For purposes of explanation, this disclosure describes video decoder 300 according to the techniques of VVC, and HEVC. However, the techniques of this disclosure may be performed by video coding devices that are configured to other video coding standards.

In the example of FIG. 7, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components. In the example of FIG. 7, motion compensation unit 316 may include a DMVR unit 317 and a BDOF unit 319.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 7 are illustrated to assist with understanding the operations performed by video decoder 300. The units may be implemented as fixed-function circuits, programmable circuits, or a combination thereof. Similar to FIG. 6, fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 6).

DMVR unit 317 of motion compensation unit 316 may use a DMVR process as part of the motion compensation process to generate a prediction block. An example of the DMVR process is described elsewhere in this disclosure. DMVR unit 317 may check one or more early termination conditions for the DMVR process. If the early termination conditions are satisfied, DMVR unit 317 may continue the DMVR process and use DMVR to generate the prediction block. Otherwise, if one or more of the early termination conditions are not satisfied, motion compensation unit 316 may generate the prediction block without using the DMVR process. In some examples of this disclosure, the early termination conditions for DMVR are modified relative to the early termination conditions for DMVR set forth in VVC Draft 6. Specifically, as one example, the equal-POC-distance constraint may be removed from the early termination conditions. Thus, in some examples, DMVR unit 317 may perform the DMVR process even if the first reference picture and the second reference picture are not equal POC distances from the current picture.

BDOF unit 319 of motion compensation unit 316 may use a BDOF process as part of the motion compensation process to generate a prediction block. An example of the BDOF process is described elsewhere in this disclosure. BDOF unit 319 may check one or more early termination conditions for the BDOF process. If the early termination conditions are satisfied, BDOF unit 319 may continue the BDOF process and use BDOF to generate the prediction block. Otherwise, if one or more of the early termination conditions are not satisfied, motion compensation unit 316 may generate the prediction block without using the BDOF process. In some examples of this disclosure, the early termination conditions for BDOF are modified relative to the early termination conditions for BDOF set forth in VVC Draft 6. Specifically, as one example, the equal-POC-distance constraint may be applied in the early termination conditions for BDOF. Thus, in some examples, BDOF unit 319 may perform the BDOF process only if the first reference picture and the second reference picture are equal POC distances from the current picture.

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 6). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to use DMVR to determine, based on a first reference picture and a second reference picture, the prediction block for a current block of a current picture of the video data, wherein the first reference picture is a first POC distance from the current picture, and the second reference picture is a second POC distance from the current picture. In accordance with one examples of this disclosure, the first POC distance is not required to be equal to the second POC distance. In some examples, motion compensation unit 316 (e.g., DMVR unit 317 of motion compensation unit 316) uses DMVR to determine the prediction block for the current block. The one or more processors of video decoder 300 may code the current block based on the prediction block for the current block.

In some examples of this disclosure, one or more processing units of video decoder 300 may use BDOF to determine, based on a first reference picture and a second reference picture, the prediction block for a current block of a current picture of the video data, wherein: the first reference picture is a first POC distance from the current picture, and the second reference picture is a second POC distance from the current picture. In such examples, the first POC distance must be equal to the second POC distance for the one or more processing units to use BDOF to determine the prediction block for the current block. For instance, at least a first constraint is imposed by a video coding standard. The first constraint requires the first POC distance to be equal to the second POC distance. Furthermore, in some such examples, the first reference picture must be before the current picture in a display order and the second reference picture must be after the current picture in the display order for the one or more processing units to use BDOF to determine the prediction block for the current block. For instance, the video coding standard may also impose a second constraint that requires the first reference picture to be before the current picture in a display order and the second reference picture to be after the current picture in the display order. In some examples, motion compensation unit 316 (e.g., BDOF unit 319 of motion compensation unit 316) uses BDOF to determine the prediction block for the current block. The one or more processors of video decoder 300 may code the current block according to the video coding standard based on the prediction block for the current block

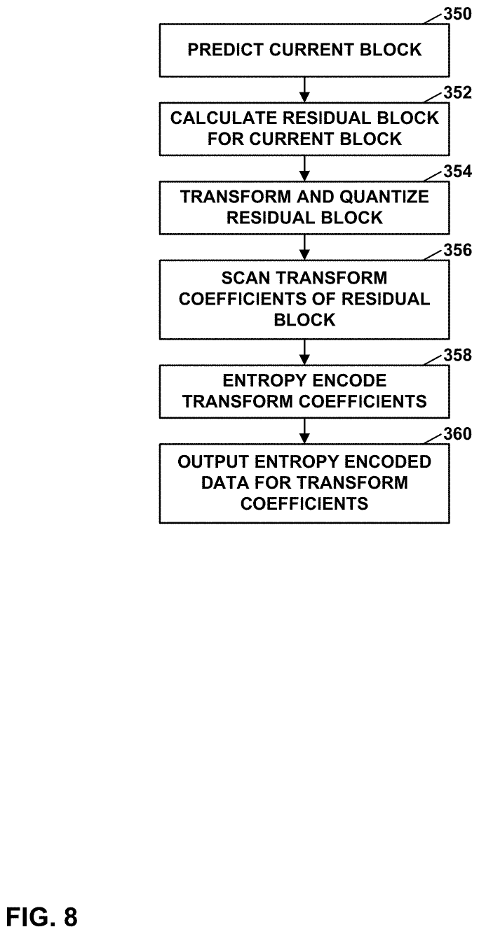

FIG. 8 is a flowchart illustrating an example method for encoding a current block. The current block may comprise a current CU. Although described with respect to video encoder 200 (FIGS. 1 and 4), it should be understood that other devices may be configured to perform a method similar to that of FIG. 8.

In this example, video encoder 200 initially predicts the current block (350). For example, video encoder 200 may form a prediction block for the current block. In some examples of this disclosure, video encoder 200 (e.g., DMVR unit 225 of video encoder 200) may use DMVR to determine, based on a first reference picture and a second reference picture, the prediction block for a current block of a current picture of the video data, wherein the first reference picture is a first POC distance from the current picture, and the second reference picture is a second POC distance from the current picture. In accordance with some examples of this disclosure, the first POC distance is not required to be equal to the second POC distance.

In some examples of this disclosure, video encoder 200 (e.g., BDOF unit 227 of video encoder 200) may use BDOF to determine, based on a first reference picture and a second reference picture, the prediction block for a current block of a current picture of the video data, wherein: the first reference picture is a first POC distance from the current picture and the second reference picture is a second POC distance from the current picture. In such examples, the first POC distance must be equal to the second POC distance for video encoder 200 to use BDOF to determine the prediction block for the current block. For instance, at least a first constraint is imposed by a video coding standard, where the first constraint requires the first POC distance to be equal to the second POC distance. In some examples, the first reference picture must be before the current picture in a display order and the second reference picture must be after the current picture in the display order for video encoder 200 to use BDOF to determine the prediction block for the current block. For instance, a second constraint is also imposed. The second constraint requires the first reference picture to be before the current picture in a display order and the second reference picture to be after the current picture in the display order.

Video encoder 200 may then calculate a residual block for the current block (352). To calculate the residual block, video encoder 200 may calculate a difference between the original, unencoded block and the prediction block for the current block. Video encoder 200 may then transform and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

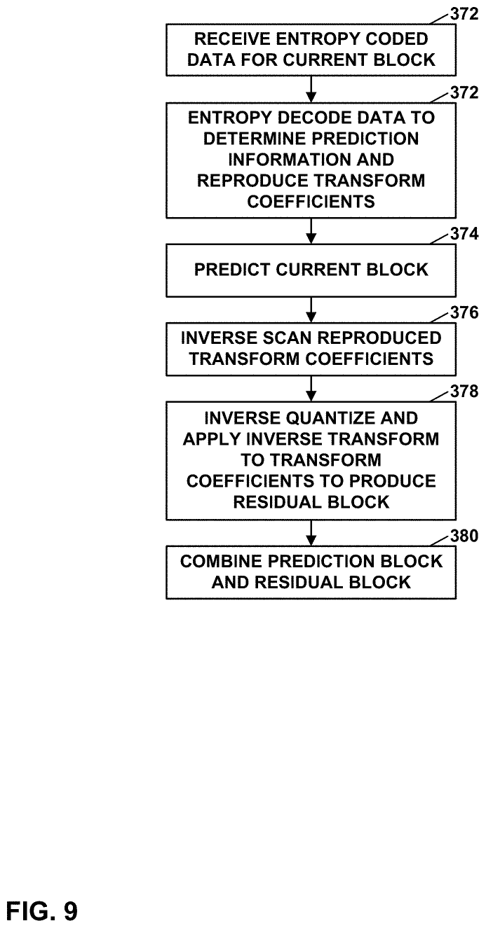

FIG. 9 is a flowchart illustrating an example method for decoding a current block of video data. The current block may comprise a current CU. Although described with respect to video decoder 300 (FIGS. 1 and 3), it should be understood that other devices may be configured to perform a method similar to that of FIG. 9.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372).

Video decoder 300 may predict the current block (374), e.g., using an intra- or inter-prediction mode as indicated by the prediction information for the current block, to calculate a prediction block for the current block. In some examples of this disclosure, video decoder 300 may use DMVR to determine, based on a first reference picture and a second reference picture, the prediction block for a current block of a current picture of the video data, wherein the first reference picture is a first POC distance from the current picture and the second reference picture is a second POC distance from the current picture. In some examples of this disclosure, the first POC distance is not required to be equal to the second POC distance.

In some examples of this disclosure, video decoder 300 may use BDOF to determine, based on a first reference picture and a second reference picture, the prediction block for a current block of a current picture of the video data, wherein: the first reference picture is a first POC distance from the current picture, and the second reference picture is a second POC distance from the current picture. The first POC distance must be equal to the second POC distance for video decoder 300 to use BDOF to determine the prediction block for the current block. For instance, at least a first constraint is imposed by a video coding standard, where the first constraint requires the first POC distance to be equal to the second POC distance. In some examples, the first reference picture must be before the current picture in a display order and the second reference picture must be after the current picture in the display order for video decoder 300 to use BDOF to determine the prediction block for the current block. For instance, the video coding standard may also impose a second constraint that requires the first reference picture to be before the current picture in a display order and the second reference picture to be after the current picture in the display order.

Video decoder 300 may then inverse scan the reproduced transform coefficients (376), to create a block of quantized transform coefficients. Video decoder 300 may then inverse quantize and inverse transform the transform coefficients to produce a residual block (378). Video decoder 300 may ultimately decode the current block by combining the prediction block and the residual block (380).

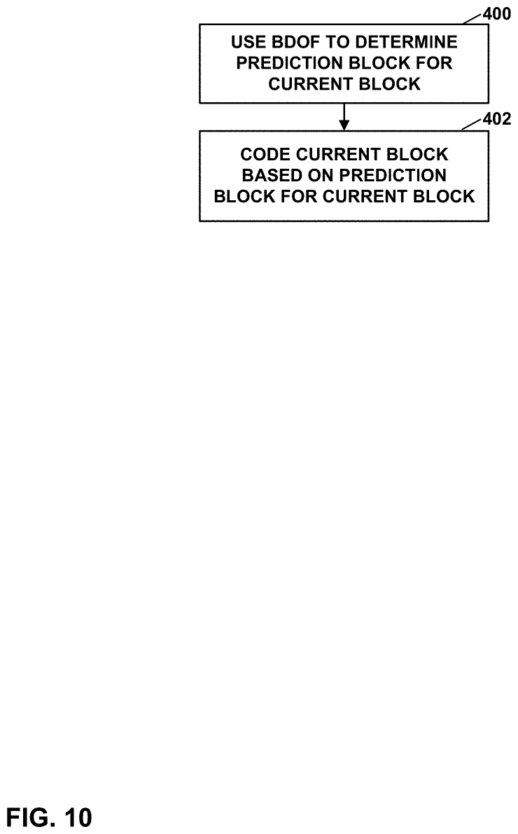

FIG. 10 is a flowchart illustrating an example method that may be performed by a video coder in accordance with one or more techniques of this disclosure. The method of FIG. 10 may be performed by video encoder 200 or video decoder 300.

In the example of FIG. 10, the video coder (e.g., BDOF unit 227 of video encoder 200 or BDOF unit 319 of video decoder 300) may use BDOF to determine, based on a first reference picture and a second reference picture, a prediction block for a current block of a current picture of the video data (400). The first reference picture is a first picture order count (POC) distance from the current picture. The second reference picture is a second POC distance from the current picture. In accordance with one or more techniques of this disclosure, the first POC distance must be equal to the second POC distance for the video coder to use BDOF used to determine the prediction block for the current block. In some examples, the first reference picture must be before the current picture in a display order and the second reference picture must be after the current picture in the display order for the video coder to use BDOF to determine the prediction block for the current block. Thus, BDOF can impose an equal-POC-distance constraint on itself, so that BDOF requires that its bi-prediction reference pictures have to come respectively from the past and future in display order, each with equal absolute POC distance relative to the current picture. Therefore, the early-termination condition of BDOF may match that of DMVR.

In examples where the video coder is video encoder 200, video encoder 200 may determine whether one or more early termination conditions for BDOF are satisfied. The one or more early termination conditions include the first POC distance being equal to the second POC distance. Other example early termination conditions for BDOF are listed elsewhere in this disclosure. Based on the early termination conditions for BDOF being satisfied, video encoder 200 (e.g., BDOF unit 319 of video encoder 200) may use BDOF to determine the prediction block for the current block.

Furthermore, in the example of FIG. 10, the video coder may code, according to the video coding standard, the current block based on the prediction block for the current block (402). In examples where the video coder is a video encoder (i.e., when coding the current block comprises encoding the current block), coding the current block based on the prediction block may comprise generating (e.g., by residual generation unit 204 of video encoder 200) residual data for the current block based on differences between samples of the current block and corresponding samples of the prediction block for the current block. In examples where the video coder is a video decoder (i.e., when coding the current block comprises decoding the current block), coding the current block based on the prediction block comprises reconstructing (e.g., by reconstruction unit 310 of video decoder 300) samples of the current block by adding samples of the prediction block for the current block and corresponding residual data for the current block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

The following is a non-limiting list of examples in accordance with one or more techniques of this disclosure.

Example 1. A method of coding video data, the method comprising: using decoder-side motion vector refinement (DMVR) to determine, based on a first reference picture and a second reference picture, a prediction block for a current block of a current picture of the video data, wherein the first reference picture is a first picture order count (POC) distance from the current picture, the second reference picture is a second POC distance from the current picture, and the first POC distance is not equal to the second POC distance; and coding the current block based on the prediction block for the current block.

Example 2. A method of coding video data, the method comprising: using bi-directional optical flow (BDOF) to determine, based on a first reference picture and a second reference picture, a prediction block for a current block of a current picture of the video data, wherein: the first reference picture is a first picture order count (POC) distance from the current picture, the second reference picture is a second POC distance from the current picture, and at least one of a first constraint and a second constraint is imposed by a video coding standard, the first constraint requiring the first POC distance to be equal to the second POC distance, the second constraint requiring the first reference picture to be before the current picture in a display order and the second reference picture to be after the current picture in the display order; and coding the current block based on the prediction block for the current block.

Example 3. The method of any of examples 1-2, wherein coding comprises decoding.

Example 4. The method of example 3, wherein coding the current block based on the prediction block comprises reconstructing samples of the current block by adding samples of the prediction block for the current block and corresponding residual data for the current block.

Example 5. The method of any of examples 1-3, wherein coding comprises encoding.

Example 6. The method of example 5, wherein coding the current block based on the prediction block comprises generating residual data for the current block based on differences between samples of the current block and corresponding samples of the prediction block for the current block.

Example 7. A device for coding video data, the device comprising one or more means for performing the method of any of examples 1-6.

Example 8. The device of example 7, wherein the one or more means comprise one or more processors implemented in circuitry.

Example 9. The device of any of examples 7 and 8, further comprising a memory to store the video data.

Example 10. The device of any of examples 7-9, further comprising a display configured to display decoded video data.

Example 11. The device of any of examples 7-10, wherein the device comprises one or more of a camera, a computer, a mobile device, a broadcast receiver device, or a set-top box.

Example 12. The device of any of examples 7-11, wherein the device comprises a video decoder.

Example 13. The device of any of examples 7-12, wherein the device comprises a video encoder.

Example 14. A computer-readable storage medium having stored thereon instructions that, when executed, cause one or more processors to perform the method of any of examples 1-6.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
using bi-directional optical flow (BDOF) to determine, based on a first reference picture and a second reference picture, a prediction block for a current block of a current picture of the video data, wherein:
the first reference picture is a first picture order count (POC) distance from the current picture,
the second reference picture is a second POC distance from the current picture, and
the first POC distance must be equal to the second POC distance for BDOF to be used to determine the prediction block for the current block; and
coding, according to the video coding standard, the current block based on the prediction block for the current block.

2. The method of claim 1, wherein the first reference picture must be before the current picture in a display order and the second reference picture must be after the current picture in the display order for BDOF to be used to determine the prediction block for the current block.

3. The method of claim 1, wherein coding the current block comprises decoding the current block.

4. The method of claim 3, wherein coding the current block based on the prediction block comprises reconstructing samples of the current block by adding samples of the prediction block for the current block and corresponding residual data for the current block.

5. The method of claim 1, wherein coding the current block comprises encoding the current block.

6. The method of claim 5, wherein coding the current block based on the prediction block comprises generating residual data for the current block based on differences between samples of the current block and corresponding samples of the prediction block for the current block.

7. The method of claim 5,
wherein the method further comprises determining that one or more early termination conditions for BDOF are satisfied, wherein the early termination conditions includes the first POC distance being equal to the second POC distance, and
using BDOF to determine the prediction block for the current block comprises, based on the one or more early termination conditions for BDOF being satisfied, using BDOF to determine the prediction block for the current block.

8. A device for coding video data, the device comprising:
a memory to store the video data; and
one or more processors implemented in circuitry, the one or more processors configured to:
use bi-directional optical flow (BDOF) to determine, based on a first reference picture and a second reference picture, a prediction block for a current block of a current picture of the video data, wherein:
the first reference picture is a first picture order count (POC) distance from the current picture,
the second reference picture is a second POC distance from the current picture, and
the first POC distance must be equal to the second POC distance for BDOF to be used to determine the prediction block for the current block; and
code, according to the video coding standard, the current block based on the prediction block for the current block.

9. The device of claim 8, wherein the first reference picture must be before the current picture in a display order and the second reference picture must be after the current picture in the display order for BDOF to be used to determine the prediction block for the current block.

10. The device of claim 8, wherein the one or more processors are configured such that coding the current block comprises decoding the current block.

11. The device of claim 10, wherein the one or more processors are configured such that, as part of coding the current block based on the prediction block, the one or more processors reconstruct samples of the current block by adding samples of the prediction block for the current block and corresponding residual data for the current block.

12. The device of claim 8, further comprising a display configured to display decoded video data.

13. The device of claim 8, wherein the one or more processors are configured such that coding the current block comprises encoding the current block.

14. The device of claim 13, wherein the one or more processors are configured such that, as part of coding the current block based on the prediction block the one or more processors generate residual data for the current block based on differences between samples of the current block and corresponding samples of the prediction block for the current block.

15. The device of claim 8, wherein the device comprises one or more of a camera, a computer, a mobile device, a broadcast receiver device, or a set-top box.

16. The device of claim 8, wherein the one or more processors are configured to:
determine that one or more early termination conditions for BDOF are satisfied, wherein the one or more early termination conditions include the first POC distance being equal to the second POC distance, and
based on the one or more early termination conditions for BDOF being satisfied, use BDOF to determine the prediction block for the current block.

17. A device for coding video data, the device comprising:
means for using bi-directional optical flow (BDOF) to determine, based on a first reference picture and a second reference picture, a prediction block for a current block of a current picture of the video data, wherein:
the first reference picture is a first picture order count (POC) distance from the current picture,
the second reference picture is a second POC distance from the current picture, and
the first POC distance must be equal to the second POC distance for BDOF to be used to determine the prediction block for the current block; and
means for coding, according to the video coding standard, the current block based on the prediction block for the current block.

18. The device of claim 17, wherein the first reference picture must be before the current picture in a display order and the second reference picture must be after the current picture in the display order for BDOF to be used to determine the prediction block for the current block.

19. The device of claim 17, wherein the means for coding the current block based on the prediction block comprises means for reconstructing samples of the current block by adding samples of the prediction block for the current block and corresponding residual data for the current block.

20. The device of claim 17,
wherein the device further comprises means for determining that one or more early termination conditions for BDOF are satisfied, wherein the one or more early termination conditions include the first POC distance being equal to the second POC distance, and
the means for using BDOF to determine the prediction block for the current block comprises means for using, based on the early termination conditions for BDOF being satisfied, BDOF to determine the prediction block for the current block.

21. A computer-readable storage medium having stored thereon instructions that, when executed, cause one or more processors to:
use bi-directional optical flow (BDOF) to determine, based on a first reference picture and a second reference picture, a prediction block for a current block of a current picture of the video data, wherein:
the first reference picture is a first picture order count (POC) distance from the current picture,
the second reference picture is a second POC distance from the current picture, and
the first POC distance must be equal to the second POC distance for BDOF to be used to determine the prediction block for the current block; and
code, according to the video coding standard, the current block based on the prediction block for the current block.
